(19) United States
(12) Patent Application Publication
(10) Pub. No.: US 2023/0128231 A1
(43) Pub. Date: Apr. 27, 2023

(54) DEVICE FOR DETERMINING THE SPEED AND/OR THE LENGTH OF A PRODUCT

(71) Applicant: Sikora AG, Bremen (DE)

(72) Inventors: Armin Holle, Achim (DE); Tuncer Kaya, Bremen (DE)

(73) Assignee: Sikora AG, Bremen (DE)

(21) Appl. No.: 17/908,614

(22) PCT Filed: Feb. 23, 2021
(86) PCT No.: PCT/EP2021/054403

§ 371 Date: Sep. 1, 2022

(30) Foreign Application Priority Data
Mar. 2, 2020 (DE) 10 2020 105 456.4

(51) Int. Cl. G01P 3/36

(52) U.S. Cl. CPC G01P 3/366; G01P 3/806

(57) ABSTRACT

A device for determining at least one of a speed and a length of a product. The device includes a laser for irradiating a surface of the product, a detector apparatus to detect laser radiation backscattered from the surface, a first sensor with a first transmission grid arranged in front of the first sensor and a second sensor. A first beam splitter splits laser radiation backscattered from the product into laser radiation conducted to at least one of the first sensor and to the second sensor. An evaluation apparatus determines at least one of: (i) the speed; and (ii) the length of the product. A third sensor is provided as is a second beam splitter that splits laser radiation coming from the first beam splitter to at least one of the sensors. The evaluation apparatus eliminates a direct component of the measurement signal received by the first sensor.

### CROSS REFERENCE TO RELATED INVENTION

This application is a national stage application pursuant to 35 U.S.C. § 371 of International Application No. PCT/EP2021/054403, filed on Feb. 23, 2021, which claims priority to, and benefit of, German Patent Application No. 10 2020 105 456.4, filed Mar. 2, 2020, the entire contents of which are hereby incorporated by reference.

### TECHNOLOGICAL FIELD

The following disclosure is directed towards a device for determining the speed and/or the length of a product, preferably a strand, moved along a conveying direction. The disclosed device includes a laser for irradiating a surface of the product and a detector apparatus for detecting laser radiation backscattered from the surface of the product.

### BACKGROUND

In the production of tubes, for example in extrusion devices, there is a need for a length measurement of the produced strand. A precise detection of the production length offers the potential for additional value creation. Contactless optical measurement methods are known from the prior art. These offer the advantage that they operate non-invasively and thus substantially without wear. By avoiding slippage, a higher measurement accuracy is also achieved and a broad range of products can be measured. The most common optical length measurement methods have in common that the length is measured indirectly via a continuous speed measurement of the product.

Optical spatial filter measuring devices are known, in which an optical pattern generated by irradiating the product surface is detected via a transmission grid by a sensor. A movement of the product and an associated movement of the optical pattern is detected by the sensor, in the simplest case as a simple intensity modulation. This measurement method is characterized by a high degree of simplicity in design and measurement technology. However, it has not become established in practice, among other reasons because it does not always deliver reliable results in the case of slow speeds, (sudden) standstill, or large positive or negative accelerations. Also, no direction differentiation of the direction of movement of the product can be made.

In other optical length measuring devices, the product surface is illuminated, for example, with an LED and the illuminated surface is imaged with an objective on an imaging sensor, for example a CCD sensor. In this case, the surface structure of the product itself serves as the optical pattern. The individual pixels can be weighted in the data capture so that the effect of a transmission grid is emulated. An advantage of these measuring devices is that multiple signals can be generated simultaneously from a raw image, for example by different grid weightings in the evaluation. This enables, for example, a directional sensitivity. These measuring devices, however, have also not become established in practice. This is due, among other things, to the limited bandwidth and spatial resolution of the imaging sensors and resulting limitations of the measurement accuracy and the measurable speed range. In addition, the use of an optical imaging unit makes the system inflexible and susceptible to distance fluctuations, which limits the depth of field. The alignment of the measuring system is complex and problems occur with very smooth product surfaces due to the use of the surface structure of the product as the optical pattern.

Above all, laser Doppler measuring devices have become established in practice. Here, the laser light backscattered from a moving surface is evaluated utilizing the Doppler effect. For example, two collimated laser beams can fall on the product at a specific angle and can be superimposed on the surface of the product. The superposition generates an interference pattern, wherein a movement of the product leads to an intensity modulation of the laser light backscattered by the surface. Without further measures, a standstill or a direction change of the product also cannot be detected with such measuring devices. Therefore, it is proposed to generate a frequency shift between the two laser measurement beams with what are called Bragg cells. As a result, the interference pattern moves over the illuminated surface region of the product and it becomes possible to detect the direction of movement or also a standstill of the product. However, Bragg cells are very costly. It is also disadvantageous in the case of laser Doppler devices that the calibration of the components of the measuring device depends on the angle of the two laser measurement beams and on the wavelength of the laser. This makes it difficult to set up the measuring device.

Starting from the explained prior art, the object of the invention is therefore to provide a device of the type in question with which a reliable measurement of the speed and/or length of the product can be achieved at any time, wherein a detection of a direction change or a standstill of the product is also possible in a manner that is reliable, simple in design, and cost-effective.

### BRIEF SUMMARY OF THE INVENTION

An embodiment of the disclosed detector apparatus comprises a first sensor with a first transmission grid arranged in front of the first sensor and a second sensor formed by an image sensor, that a first beam splitter is also provided which splits laser radiation backscattered from the product into laser radiation conducted, on the one hand, to the first sensor and, on the other hand, to the image sensor, and that an evaluation apparatus is provided which is designed to determine the speed and/or the length of the product based on an intensity modulation detected by the first sensor during a movement of the product and/or based on a shift of a speckle pattern formed on the image sensor detected by the image sensor during a movement of the product.

The product can be, in particular, a strand. The strand can be a tubular strand. The strand is conveyed through the device in particular along its longitudinal axis. However, the product can also be, for example, a film, a plate, or another profile. To convey the product through the device, the device can comprise a corresponding conveying apparatus. The product can be, for example, made of plastic or metal or glass. The product can come, for example, from an extrusion device in which the product is produced by extrusion. The device can also comprise an extrusion device.

In an embodiment of the disclosed device, the surface of the product is irradiated with a laser and laser radiation is scattered by the product. A first sensor is provided and a first transmission grid is arranged in front of the first sensor in the beam path of the laser radiation. Radiation backscattered from the product reaches the first transmission grid accordingly. A speckle pattern is formed at the first transmission grid. A speckle pattern is formed by interference of sufficiently coherent radiation, in this case the laser radiation, which has been scattered from points of different heights on the surface of the product and accordingly has a path difference generating the interference pattern (speckle pattern). Corresponding to the speckle pattern formed at the first transmission grid, radiation passes through the first transmission grid and is detected by the first sensor. A movement of the product in the conveying direction generates a corresponding movement of the speckle pattern on the transmission grid. This leads to a corresponding modulation of the radiation intensity received by the first sensor. From the frequency of the intensity modulation, the speed of the product and from it in turn the length of the product can be inferred in a known manner between various measurement times. In this case, the modulation frequency is in particular proportional to the speed of the product. In particular with collimated laser beams, it is not influenced by movements of the product in a direction other than the conveying direction. It is therefore preferably possible to use collimated laser radiation. The traveled distances of the product and speckle pattern on the transmission grid are then identical regardless of any movements of the product in a direction other than the conveying direction. The use of collimated laser radiation is, however, not strictly necessary. Rather, it is also possible to not use collimated laser radiation or only use it partially.

An infrared laser, for example, can be considered as the laser. The speckle pattern is an objective speckle pattern, meaning a speckle pattern that is formed only through propagation of radiation scattered on a sufficiently rough surface and propagating in space. Since the speckle pattern is first formed on the first transmission grid, it is always focused thereon. Thus, no optical imaging unit is required. In particular, it is thus possible that, in the device according to the invention, no optical imaging unit is arranged between the product and the first sensor. This makes the structure and the setup of the device according to the invention simple and cost-effective. In addition, various working distances from the product can thus be realized and fluctuations in the distance during the measurement or between different measurements can be tolerated. By using a speckle pattern, a high contrast is created even on very smooth surfaces with a roughness on the order of magnitude of the laser wavelength, which ensures a high signal quality. Very smooth surfaces can also be measured reliably. As a result of the considerably higher bandwidth, in particular compared to imaging sensors such as CCD sensors, the first sensor can measure in the same speed ranges with the spatial filter method as laser Doppler measuring devices.

As explained above, however, spatial filter methods are problematic in principle for very slow speeds of the product, in particular when the product is at a standstill. A direction detection with the spatial filter method is, as explained previously, also not possible to date without reducing the measurement accuracy and the speed range. In order to still enable a directional sensitivity and a measuring possibility at very low conveying speeds up to a standstill in a simple and cost-effective manner, the device according to the invention combines the explained spatial filter method with image detection of the speckle pattern generated by the irradiation of the product surface with laser light. For this purpose, the device comprises a second sensor in the form of an image sensor, meaning a sensor that has a sensor surface with two-dimensional resolution. The speckle pattern is also formed on the sensor surface of the image sensor. By using a beam splitter, both sensors see the same region of the product surface or respectively laser radiation scattered from the same region of the product surface. They thus also detect the same speckle pattern. The first transmission grid can be arranged in this case between the first beam splitter and the first sensor. The evaluation apparatus evaluates the measurement result of the second sensor (of the image sensor) according to what is called the optical flow tracking method, which is also used, for example, in optical computer mice. In this case, the fact that the speckle pattern formed on the image sensor shifts on the sensor surface in correspondence with the conveying movement of the product is utilized. From this shift of the speckle pattern, a speed and therefore length measurement of the product, on the one hand, is possible even at very low conveying speeds up to a standstill. On the other hand, a directional sensitivity is also given, wherein in particular movements transverse to the conveying direction can also be measured. Since the data evaluation is based on a correlation analysis, slow conveying speeds can be measured considerably more efficiently with the image sensor than in the case of a spatial filter measurement system with an optical grid which is designed for a very wide speed range.

The disclosed device thus combines a spatial filter measurement with an imaging measurement according to the optical flow tracking method, wherein both sensors see the same speckle pattern due to the arrangement with the beam splitter. In this way, the speed and the length of the product can be measured in a large speed range up to a standstill while also detecting the direction in a manner that is reliable, simple in design, and cost-effective. The first sensor can serve here as the main sensor, which measures the speed and/or length of the product in regular operation when it has reached its operating speed. The second sensor (image sensor) can be used as an auxiliary sensor at low conveying speeds of the product up to a standstill and/or for detecting direction. In this case, even very large acceleration values are not a problem for a reliable measurement. A particularly small distance between the detector apparatus and the product is also possible, for example, of less than 10 cm, which allows a better evaluation of in particular very small, in particular very thin, or respectively very smooth products. In addition, any protective housings that are to be provided can be designed to be more compact, which further reduces the complexity and the costs of the device. Dust or other disruptive factors in the beam path have a smaller influence. With the known laser Doppler devices, expensive additional protective equipment is required for this. In addition, in the device according to the invention, the angle between the laser beam and the product does not have a relevant influence on the measurement result. This allows for simple calibration.

According to one embodiment, a first lens focusing the laser radiation supplied to the first sensor onto the first sensor can be arranged between the first transmission grid and the first sensor. The focusing lens ensures that all of the radiation passing through the transmission grid is supplied to the first sensor and is thus available for the evaluation.

In a particularly practical manner, the first sensor can be a photodiode. A crucial advantage of a photodiode as opposed to an image sensor is the higher bandwidth of the photodiode. In an embodiment, silicon photodiodes can be used as they have a high sensitivity, for example, to common infrared lasers.

According to another embodiment, a second lens focusing the laser radiation conducted to the image sensor can be arranged between the first beam splitter and the image sensor. While the speckle pattern in the beam path of the first sensor is formed at the first transmission grid, as explained, the speckle pattern in the beam path of the image sensor (second sensor) is formed on the sensor surface. A focusing lens can focus the laser radiation on a measurement opening of the image sensor, so that all of the laser radiation can be evaluated. The evaluation of the measurement signals can be further improved in this way. The focusing lens can be arranged directly in front of the image sensor and/or, for example, directly behind the first beam splitter in order to collect more radiation, for example, in the case of larger distances or smaller products.

According to another embodiment, the image sensor can be a CCD sensor or a CMOS sensor. According to another embodiment, it is possible that the detector apparatus also comprises a third sensor, and that a second beam splitter is arranged between the first beam splitter and the image sensor and splits laser radiation coming from the first beam splitter into laser radiation conducted to the image sensor, on the one hand, and to the third sensor, on the other hand According to another embodiment, it is also possible that the detector apparatus also comprises a third sensor, and that a second beam splitter is arranged between the first beam splitter and the first transmission grid and splits laser radiation coming from the first beam splitter into laser radiation conducted to the first sensor on the one hand and to the third sensor on the other hand According to another embodiment, the evaluation apparatus can calculate the difference of the measurement signals from the first sensor and the third sensor in order to determine the speed and/or the length of the product. The measurement signal received by the first sensor contains what is called a direct component as an offset. With the aforementioned embodiment, this direct component can be eliminated in that the measurement signals from the third sensor are subtracted from the measurement signals from the first sensor. The differential signal thus obtained no longer contains a direct component, which considerably improves the signal-to-noise ratio and thus the detectability of the signals. If the product vibrates, for example, or has a periodic surface structure, periodic intensity fluctuations can occur, which in turn lead to interference frequencies in the signal. Without further measures, such interference frequencies cannot always be distinguished from the actual modulation frequency of the useful signal. In the embodiment described here, only the signal from the first sensor contains the useful signal, such that frequencies detected in both the first and the third sensor can be clearly identified as interferences. This further improves the evaluation of the measurement signal.

According to another embodiment, a second transmission grid can be arranged in front of the third sensor, wherein the second transmission grid is phase-shifted by 180° compared to the first transmission grid. With this embodiment, not only the direct component is eliminated, but a maximum amplification of the intensity modulation signal, in particular of the corresponding signal vibration, also takes place due to the phase shift of the transmission grids by 180°. However, this requires an exact positioning of the two transmission grids, which may be too complex depending on the use case. Accordingly, it is also possible that no transmission grid is arranged in front of the third sensor. The problem of the exact positioning is thereby avoided. The vibration signal is not amplified, but the direct component is still eliminated. Depending on the use case, this solution can be sufficient or respectively preferred accordingly.

In an embodiment, the third sensor can be a photodiode. It can be in turn, for example, a silicon photodiode, which has a particularly high sensitivity to common infrared lasers.

According to another embodiment, the evaluation apparatus can be configured to determine a shift of the speckle pattern detected by the image sensor in a direction transverse to the conveying direction of the product. An adjusting apparatus for adjusting the point of incidence of the laser radiation on the product at least in a direction transverse to the conveying direction of the product can also be provided, and the evaluation apparatus can be designed to control the adjusting apparatus on the basis of a determined shift of the speckle pattern detected by the image sensor in a direction transverse to the conveying direction of the product in order to adjust the point of incidence of the laser radiation on the product at least in a direction transverse to the conveying direction of the product. In measuring devices in the prior art, in particular in the case of thin products, such as thin strand products, the problem arises that a lateral shift of the product that may not be detected leads to an inadequate irradiation or respectively measurement of the product by the laser radiation. The lateral tolerance, meaning transverse to the conveying direction of the product, is typically only a few millimeters, corresponding to the size of the laser spot on the surface. Since the device according to the invention also detects transverse movements of the product, meaning transverse to the conveying direction, with the image sensor, this can be used for lateral adjustment of the laser by the evaluation apparatus. The adjusting apparatus can comprise, for example, a mirror with a galvanometer drive or similar. By controlling the adjusting apparatus by means of the evaluation apparatus, the direction of the laser in the transverse direction to the conveying direction can be regulated such that the product can always be optimally illuminated and measured. This allows considerably larger tolerances to be realized transversely to the conveying direction than in the prior art, for example on an order of magnitude of up to 100 mm for a realization with an approximately 25 mm large optical unit at working distances of up to 500 mm.

According to another embodiment, a distance setting apparatus can also be provided, with which the distance of the laser and/or the detector apparatus from the surface of the product can be set. The distance setting apparatus can also be controlled by the evaluation apparatus. Such a distance setting is advantageous since, in this manner, the device, in particular the detector apparatus, and possibly also the laser, can be moved closer to the product. As already explained above, a small distance from the product offers a variety of advantages, in particular with regard to particularly thin and smooth products, in particular strand products, and also in relation to protective measures against and influence of disruptive particles. The device according to the invention can also comprise an apparatus for tilting the laser so that the spot illuminated by the laser on the surface of the product can always be held, for example, vertically below the detector apparatus even with different distances between the laser and the product surface.

According to another embodiment, a laser beam splitter can also be provided which conducts laser radiation emitted by the laser vertically onto the surface of the product. The laser radiation can be coupled directly into the beam path of the detector apparatus, in particular of the first and second sensors, by the laser beam splitter. In particular, in this case laser radiation backscattered vertically from the product surface can strike the first beam splitter in the middle and possibly the first and/or second sensor. In this embodiment, the angle of incidence of the laser does not have to be adjusted for a different working distance. This enables even greater depths of field since the laser spot does not move to the left or right with a back-and-forth movement of the product.

### BRIEF DESCRIPTION OF THE DRAWINGS

Exemplary embodiments of the invention are explained in greater detail below based on drawings. Schematically:

FIG. 1 illustrates an embodiment of a device for determining the speed and/or the length of a product;

FIG. 2 illustrates another embodiment of the device for determining the speed and/or the length of a product;

FIG. 3 illustrates an embodiment of setting an embodiment of a laser;

FIG. 4A illustrates a partial view of an embodiment of an adjusting apparatus for adjusting the point of incidence of the laser radiation;

FIG. 4B illustrates another partial view of the embodiment of FIG. 4A;

FIG. 4C illustrates another partial view of the embodiments of FIG. 4A and 4B; and

FIG. 5 illustrates another embodiment of the device for determining the speed and/or the length of a product.

The same reference signs refer to the same objects in the figures unless indicated otherwise.

### DETAILED DESCRIPTION OF THE INVENTION

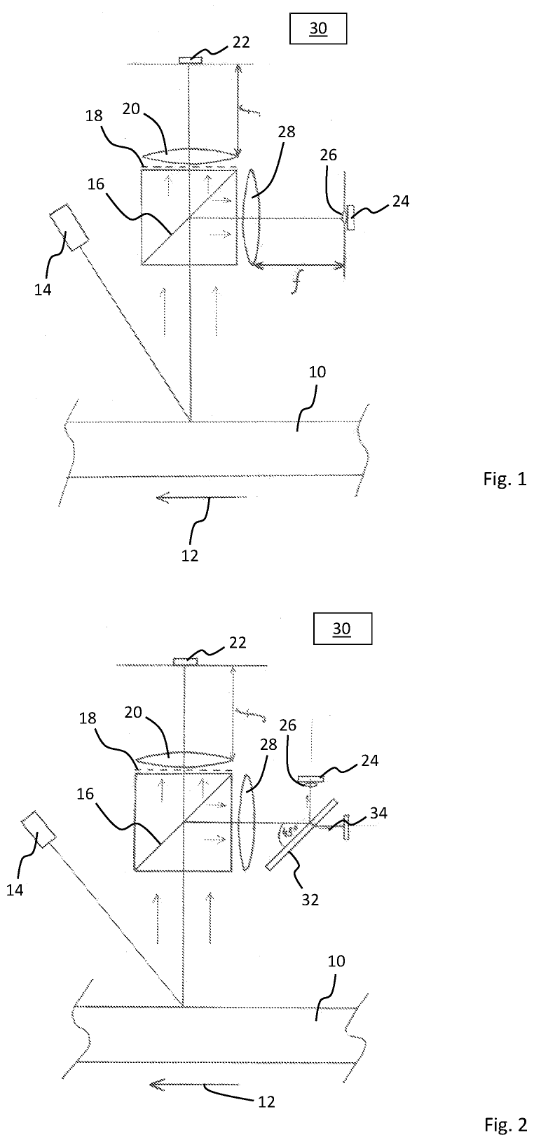

FIG. 1 shows a section of a tubular strand 10 which is conveyed by means of a conveying apparatus (not shown) along a conveying direction, as illustrated by the arrow 12. The conveying direction runs in the direction of the longitudinal axis of the strand 10. Laser radiation is conducted onto the surface of the strand 10 by means of a laser 14. Laser radiation scattered from the surface is split into two radiation components by means of a first beam splitter 16. A first radiation component strikes a first transmission grid 18. Laser radiation passing through the first transmission grid 18 is focused by a first lens 20 onto a first sensor 22, which can be, for example, a photodiode. A second radiation component reaches a second sensor 24, which is an image sensor, for example a CCD sensor or a CMOS sensor. A focusing second lens 26, arranged directly in front of the image sensor 24, can be provided. Alternatively or additionally, a focusing second lens 28 can also be arranged directly after the first beam splitter 16. The radiation coming from the first radiation splitter 16 is focused onto a measuring opening of the image sensor 24 by the second lens 26 and/or 28.

By using coherent laser light, a speckle pattern is formed on the first transmission grid 18, on the one hand, and on the sensor surface of the image sensor 24, on the other hand. This speckle pattern is characterized by the surface structure of the strand 10 and moves accordingly with the strand 10. As a result, the first sensor 22 detects an intensity modulation with a modulation frequency that is characteristic of the movement of the strand 10. On the other hand, the speckle pattern shifts on the sensor surface of the image sensor 24 and the image sensor 24 detects this shift. The measurement signals from the first sensor 22 and from the image sensor 24 are supplied to an evaluation apparatus 30. The evaluation apparatus 30 determines the speed and/or the length of the strand between different measurement times based on the intensity modulation detected by the first sensor 22 and/or based on the shift of the speckle pattern detected by the image sensor 24.

The embodiment in FIG. 2 largely corresponds to the device from FIG. 1. In contrast to the device from FIG. 1, in the case of the device in FIG. 2, a second beam splitter 32 is arranged between the first beam splitter 16 and the image sensor 24 and splits laser radiation coming from the first beam splitter 16 into laser radiation conducted to the image sensor 24 on the one hand and to a third sensor 34 on the other hand. The third sensor 34 can also be formed by a photodiode. In addition to the measurement signals from the first sensor 22 and the image sensor 24, in the exemplary embodiment according to FIG. 2, the measurement signals from the third sensor 34 are also conducted to the evaluation apparatus 30. The evaluation apparatus 30 calculates a difference between the measurement values of the first sensor 22 and the third sensor 34 in order to eliminate a direct component in the measurement signal. This improves the signal-to-noise ratio and increases the measurement accuracy. It is possible to arrange a second transmission grid, which is phase-shifted by 180° compared to the first transmission grid 18, in front of the third sensor 34, in particular between the second beam splitter 32 and the third sensor 34. In the case of a differential formation between the sensor signals from the first and third sensors 22, 34, this additionally leads to a maximum amplification of the measured modulation signal.

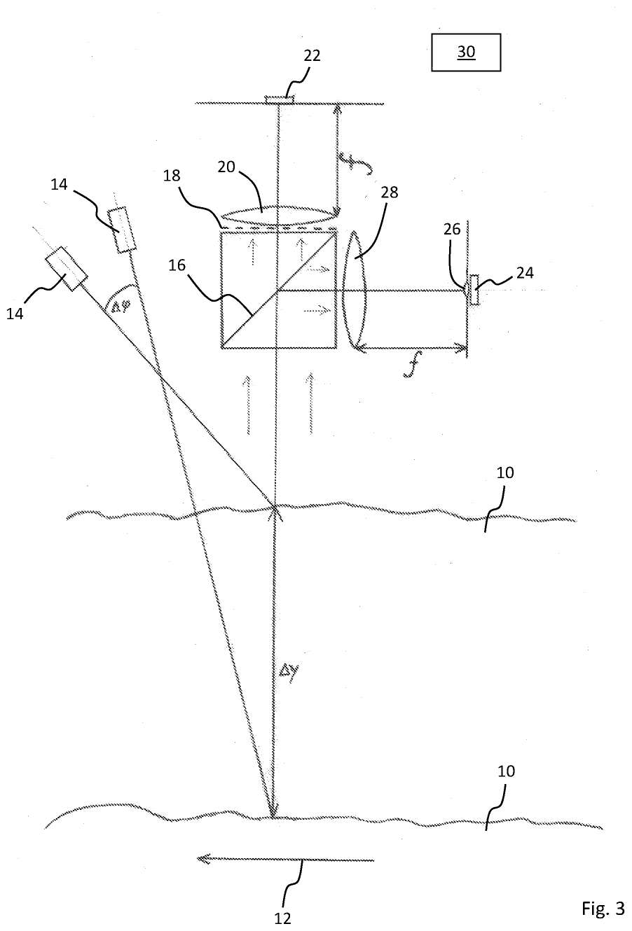

The embodiment shown in FIG. 3, illustrates how tilting the laser 14 of FIG. 1 can ensure an ability to adjust to different distances between the surface of the strand 10 and the device, in particular the sensors 22, 24 or respectively the beam splitter 16. In this case, two strand surfaces at different distances from the device and correspondingly two different positions of the laser 14 are shown. Tilting the laser 14 ensures that the laser radiation always strikes the strand surface in the middle vertically below the beam splitter 16. This of course applies in the same manner to the exemplary embodiment shown in FIG. 2. Due to the omission of an optical imaging unit between the strand 10 and the sensors 22, 24 and possibly 34 in the devices shown according to the invention, and due to the fact that the speckle pattern formed on the first transmission grid 18 or respectively the image sensor 24 is always sharp, no additional calibration measures are required when tilting the laser 14, in a particularly simple manner.

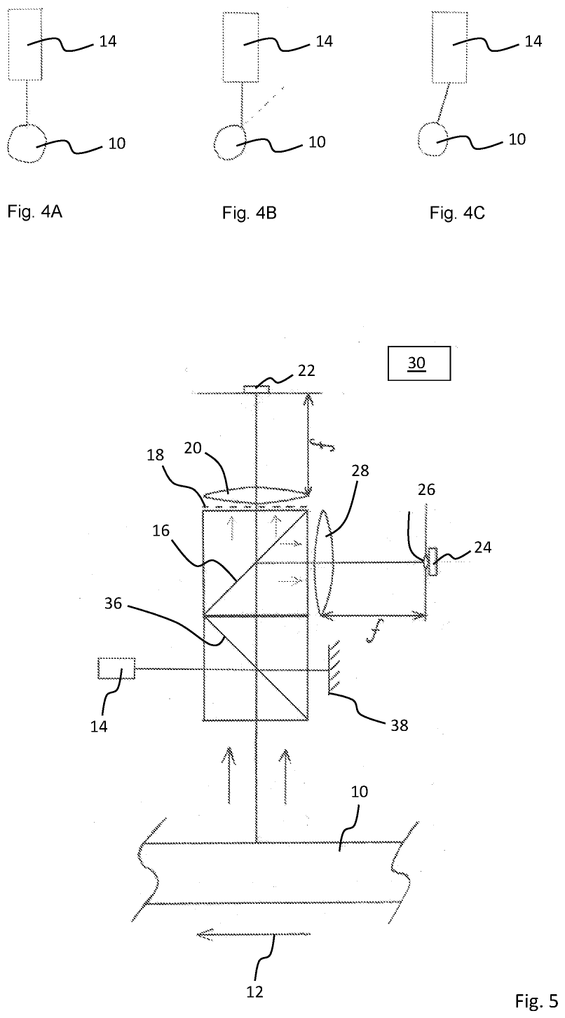

In FIGS. 4A-C, an adjusting apparatus integrated into the laser 14 for adjusting the point of incidence of the laser radiation on the strand 10 in a direction transverse to the conveying direction of the strand 10 is shown very schematically. This can be used in each of the exemplary embodiments shown. In FIGS. 4A-C, three different partial views are shown which show different states. In all three partial views show in FIGS. 4A-C, the conveying direction of the strand 10 runs perpendicularly into the plane of the drawing. In FIG. 4A, a state is shown in which laser radiation from the laser 14 strikes the surface of the strand 10 in the middle vertically downward. Striking it in the middle is the desired state. FIG. 4B illustrates a state in which the strand 10 has moved transversely to the conveying direction, in the partial view somewhat to the left. As a result, the point of incidence of the laser radiation, which continues to exit the laser 14 vertically downward, is no longer in the middle on the strand surface. This leads to a non-optimal illumination of the strand surface and can, with a correspondingly pronounced lateral shift of the strand 10, even lead to the strand 10 completely exiting the range of the laser radiation. The lateral shift of the strand 10 can be detected based on an evaluation of the measurement signal of the image sensor 24, in particular by a corresponding shift of the speckle pattern on the sensor surface of the image sensor 24, evaluated by the evaluation apparatus 30. The evaluation apparatus 30 can then control the adjusting apparatus in order to adapt the point of incidence of the laser radiation to the strand surface such that it is again in the middle of the strand 10, as shown in FIG. 4C. The adjusting apparatus can, for example, in a particularly simple manner comprise an adjustable mirror conducting the laser radiation onto the strand surface. The mirror can be adjusted, for example, by means of a galvanometer drive.

FIG. 5 shows a further exemplary embodiment of a device according to the invention which largely corresponds to the exemplary embodiment according to FIG. 1. Additionally, a laser beam splitter 36 is provided here, which conducts laser radiation emitted by the laser 14 vertically onto the surface of the strand 10. In this case, the laser radiation is coupled directly into the beam path of the detector apparatus, in particular of the first and second sensors (22, 24), by the laser beam splitter 36. In particular, laser radiation backscattered vertically from the strand surface strikes the first beam splitter 16 and the first and second sensors 24, 26 in the middle. Laser radiation backscattered vertically from the strand surface also runs through the first and second lenses 20, 28 in the middle. A beam dump 38 is arranged on the side of the laser beam splitter 36 opposite the laser 14 in order to prevent laser radiation from passing through the laser beam splitter 36 and contacting the sensors 24, 26 directly. The component of the laser radiation that is directly let through by the laser beam splitter 36 is absorbed by the beam dump 38. Of course, the embodiment according to FIG. 5 can also be combined, for example, with the exemplary embodiment from FIG. 2.

### LIST OF REFERENCE SIGNS

10 Strand
12 Conveying direction
14 Laser
16 First beam splitter
18 First transmission grid
20 First lens
22 First sensor
24 Second sensor (image sensor)
26 Second lens
28 Second lens
30 Evaluation apparatus
32 Second beam splitter
34 Third sensor
36 Laser beam splitter
38 Beam dump

1-11. (canceled)

12. A device for determining at least one of a speed and a length of a product moving along a conveying direction, comprising:
a laser configured to irradiate a surface of the product,
a detector apparatus configured to detect laser radiation backscattered from the surface of the product;
a first sensor with a first transmission grid arranged in front of the first sensor;
a second sensor formed by an image sensor;
a first beam splitter configured to split laser radiation backscattered from the product into laser radiation conducted to at least one of the first sensor and to the image sensor;
an evaluation apparatus configured to determine at least one of: (i) the speed; and (ii) the length of the product based on: (i) an intensity modulation detected by the first sensor during a movement of the product; and (ii) a shift of a speckle pattern formed on the image sensor detected by the image sensor during a movement of the product;
a third sensor;
a second beam splitter positioned between the first beam splitter and the image sensor and is configured to split laser radiation coming from the first beam splitter into laser radiation conducted to at least one of: (i) the image sensor; (ii) the first sensor; and (iii) the third sensor,
wherein the evaluation apparatus is configured to calculate a difference in measurement signals from the first sensor and from the third sensor in order to determine at least one of: (i) the speed; and (ii) the length of the product so that a direct component of the measurement signal received by the first sensor is eliminated.

13. The device according to claim 12, further comprising a first transmission grid and a first lens positioned between a first transmission grid and the first sensor, wherein the first lens is configured to focus the laser radiation onto the first sensor.

14. The device according to claim 12, wherein the first sensor is a photodiode.

15. The device according to claim 13, further comprising a second lens positioned between the first beam splitter and the image sensor and configured to focus the laser radiation conducted to the image sensor.

16. The device according to claim 12, wherein the image sensor is one of: (i) a CCD sensor or (ii) a CMOS sensor.

17. The device according to claim 13, further comprising a second transmission grid positioned in front of the third sensor, wherein the second transmission grid is phase-shifted by 180° compared to the first transmission grid.

18. The device according to claim 12, wherein the third sensor is a photodiode.

19. The device according to claim 12, wherein the evaluation apparatus is configured to determine a shift of the speckle pattern detected by the image sensor in a direction transverse to the conveying direction of the product.

20. The device according to claim 19, further comprising an adjusting apparatus configured to adjust a point of incidence of the laser radiation on the product at least in a direction transverse to the conveying direction of the product, wherein that the evaluation apparatus is configured to control the adjusting apparatus to adjust the point of incidence of the laser radiation on the product at least in a direction transverse to the conveying direction of the product, and wherein the adjusting apparatus is controlled based on the determined shift of the speckle pattern detected by the image sensor in the direction transverse to the conveying direction of the product.

21. The device according to claim 12, further comprising a distance setting apparatus configured to set a distance of at least one of the laser and the detector apparatus from the surface of the product.

22. The device according to claim 12, further comprising a laser beam splitter configured to conduct laser radiation vertically onto the surface of the product.
